(19) United States
(12) Patent Application Publication
(10) Pub. No.: US 2008/0291368 A1
(43) Pub. Date: Nov. 27, 2008

(54) Display Device Comprising Multiple Display Panel Assemblies

(76) Inventors: Joon-Hyung Park, Seoul (KR); Jong-Ho Son, Seoul (KR); Min-Goo Seok, Yongin-si (KR)

Correspondence Address: Frank Chau, Esq.;F. CHAU & ASSOCIATES, LLC, 130 Woodbury Road, Woodbury, NY, 11797, US

(21) Appl. No.: 12/124,368

(22) Filed: May 21, 2008

(30) Foreign Application Priority Data
May 22, 2007 (KR) 10-2007-0049918
Oct. 19, 2007 (KR) 10-2007-0105649

(51) Int. Cl. G02F 1/1333

(52) U.S. Cl. 349/74

(57) ABSTRACT

A display device includes a first and second display panel assembly. The first panel assembly includes a first substrate, a second substrate opposite to the first substrate, a liquid crystal layer formed between the first substrate and the second substrate, a color filter formed on the first substrate or the second substrate, and a first light blocking member formed on the first substrate or the second substrate. The second panel assembly includes a third substrate, a fourth substrate opposite the third substrate, and a liquid crystal layer formed between the third substrate and the fourth panel. The second panel assembly does not have a color filter. The first panel assembly and the second panel assembly are overlapped with each other. Accordingly, the moiré interference effects may be prevented.

### CROSS-REFERENCE TO RELATED APPLICATION

This application claims priority to Korean Patent Application No. 10-2007-0049918, filed in the Korean Intellectual Property Office on May 22, 2007 and to Korean Patent Application No. 10-2007-0105649, filed in the Korean Intellectual Property Office on Oct. 19, 2007, the entire contents of which are incorporated herein by reference.

### BACKGROUND OF THE INVENTION

(a) Technical Field

The present invention relates to a display device, and more particularly, to a display device comprising multiple display panel assemblies.

(b) Discussion of the Related Art

A liquid crystal display (LCD) is a widely used flat panel display. The LCD includes a pair of panels provided with field-generating electrodes, such as pixel electrodes and a common electrode. A liquid crystal (LC) layer is interposed between the two panels. The LCD displays images by applying voltages to the field-generating electrodes to generate an electric field in the LC layer that determines the orientations of LC molecules therein to adjust polarization of incident light.

Frequently, a liquid crystal display has a structure in which field generating electrodes are respectively provided on two display panels. Particularly, a liquid crystal display may have a structure in which a plurality of pixel electrodes are arranged on a display panel in a matrix shape and a common electrode covers an entire surface of another display panel. Recently, attention has been given to developing a liquid display device having a high contrast ratio on the order of 1,000,000:1.

### SUMMARY OF THE INVENTION

When forming one display device by overlapping two display panel assemblies such a display device, patterns that are periodically arranged such as pixel electrodes and light blocking members in each display panel assembly may be overlapped such that moiré interference is generated. The moiré interference is generated when spatial patterns having periodic characteristics are overlapped and interference patterns having a larger period than an original period are formed. This moiré interference may deteriorate the display quality of the display device.

Accordingly, exemplary embodiments of the present invention increase the reliability of a display device by reducing or preventing the generation of moiré interference in a display device including dual panels.

A display device according to an exemplary embodiment of the present invention includes first and second panel assemblies. The first panel assembly includes a first lower panel including a first substrate, first thin film elements formed on the first substrate and including at least one thin film transistor and a first pixel electrode formed on the first thin film elements, a first upper panel including a second substrate opposite to the first substrate and a first common electrode formed on the second substrate, a liquid crystal layer formed between the first lower panel and the first upper panel, a color filter formed on one of the first lower panel and the first upper panel, and a first light blocking member formed on one of the first lower panel and the first upper panel. The second panel assembly includes a second lower panel including a third substrate, second thin film elements formed on the third substrate and including at least one thin film transistor and a second pixel electrode formed on the second thin film elements, a second upper panel including a fourth substrate opposite the third substrate and a second common electrode formed on the fourth substrate, and a liquid crystal layer formed on the second lower panel and the second upper panel. The second panel assembly does not have a color filter and the first panel assembly and the second panel assembly are overlapped with each other.

A diffuser disposed between the first panel assembly and the second panel assembly may be further included, and a polarizer disposed between the first panel assembly and the second panel assembly and having a predetermined light dispersion degree may be further included.

The fourth substrate of the second panel assembly may further include a second light blocking member having a different shape from the first light blocking member. The first light blocking member may enclose a region corresponding to each first pixel electrode while the second light blocking member may enclose a region corresponding to one dot including three second pixel electrodes.

One of the second pixel electrodes may be employed on a region corresponding to three first pixel electrodes, the first light blocking member may enclose a region corresponding to each first pixel electrode, and the second light blocking member may enclose a region corresponding to each second pixel electrode.

The highest gray voltage among the gray voltages applied to the first pixel electrodes opposite to the second pixel electrode may be applied to the second pixel electrode.

The fourth substrate of the second display panel assembly may further include a second light blocking member having a different shape than the first light blocking member. The first light blocking member may enclose the region corresponding to each first pixel electrode while the second light blocking member may enclose the region corresponding to one dot including the three second pixel electrodes.

One of the second pixel electrodes may be employed on the region corresponding to the three first pixel electrodes, and the highest gray voltage among the gray voltages applied to the first pixel electrodes opposite to the second pixel electrode may be applied to the second pixel electrode.

The color filter may be formed in the first lower panel. The first light blocking member may be formed in the first upper panel. The color filters may include red, green, blue, and white color filters.

The color filter and the first light blocking member may be formed in the first lower panel, and the color filters may include red, green, blue, and white color filters.

A display device includes first and second display panel assemblies. The first display panel assembly includes first thin film elements including at least one first thin film transistor, a first pixel electrode for being switched by the first thin film transistor, a first common electrode opposing the first pixel electrode, and a light blocking member. The second display panel assembly includes second thin film elements including at least one second thin film transistor, a second pixel electrode for being switched by the second thin film transistor, and a second common electrode opposing the second pixel electrode. The second display panel assembly does not have a light blocking member. The first display panel assembly and the second display panel assembly are overlapped with each other.

A diffuser disposed between the first display panel assembly and the second display panel assembly may be further included, and a polarizer disposed between the first display panel assembly and the second display panel assembly and having a predetermined light dispersion degree may be further included.

The polarizer may have a light dispersion degree of 70-100 haze, and one second pixel electrode may be employed on a region corresponding to three first pixel electrodes.

The second pixel electrode may be employed on a region corresponding to three first pixel electrodes. The highest gray voltage among the gray voltages applied to the first pixel electrodes opposite to the second pixel electrode may be applied to the second pixel electrode.

According to an exemplary embodiment of the present invention, the diffuser is disposed between the lower panel assembly and the upper panel assembly such that the path of light from the backlight is changed thereby reducing or preventing the moiré interference effects.

In an exemplary embodiment of the present invention, the color filter is not formed on one panel of the upper panel assembly and the lower panel assembly. One pixel electrode of the panel assembly has a larger size than another pixel electrode. The light blocking members of the upper and lower panel assemblies have different repeating periods. Accordingly, the upper panel assembly and the lower panel assembly include the light blocking member, the color filters, and the pixel electrodes, which are regularly and repeatedly formed and have different repeating periods to thereby prevent the moiré interference effects.

### BRIEF DESCRIPTION OF THE DRAWINGS

FIG. 1 is a perspective view of a liquid crystal display according to an exemplary embodiment of the present invention;

FIG. 2 is a perspective view of a liquid crystal display according to an exemplary embodiment of the present invention;

FIG. 3 is a cross-sectional view of the liquid crystal display shown in FIG. 2 taken along the line III-III;

FIG. 4 is a perspective view of a liquid crystal display according to an exemplary embodiment of the present invention;

FIG. 5 is a cross-sectional view of the liquid crystal display shown in FIG. 4 taken along with the line V-V;

FIG. 6 is a perspective view of a liquid crystal display according to an exemplary embodiment of the present invention;

FIG. 7 is a cross-sectional view of the liquid crystal display shown in FIG. 6 taken along with the line VII-VII;

FIG. 8 is a perspective view of a liquid crystal display according to an exemplary embodiment of the present invention;

FIG. 9 is a cross-sectional view of the liquid crystal display shown in FIG. 8 taken along with the line IX-IX;

FIG. 10 is a cross-sectional view of a liquid crystal display according to an exemplary embodiment of the present invention;

FIG. 11 is a cross-sectional view of a liquid crystal display according to an exemplary embodiment of the present invention;

FIG. 12 and FIG. 13 are views showing moiré interference due to overlapping of color filters; and

FIG. 14 to FIG. 16 are views showing moiré interference due to the overlapping of the light blocking members.

### DETAILED DESCRIPTION OF EXEMPLARY EMBODIMENTS

The above and other features and aspects of the exemplary embodiments of the present invention will be described in detail with reference to the accompanying drawings. As those skilled in the art would realize, the described embodiments may be modified in various different ways, all without departing from the spirit or scope of the present invention.

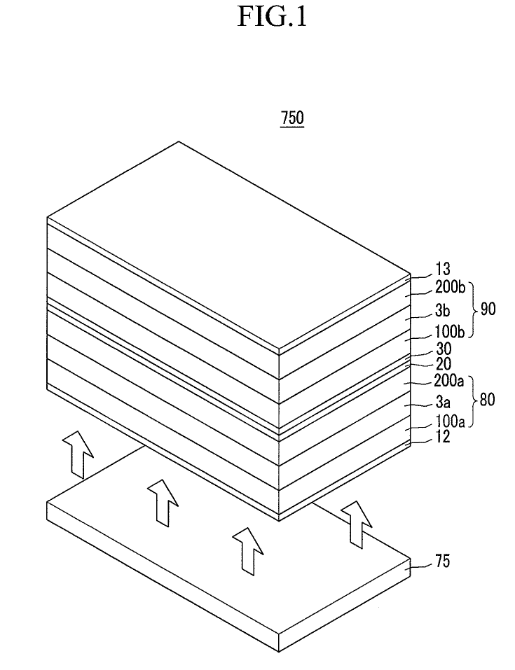

The structure of an LCD according to an exemplary embodiment of the present invention will be described below in detail with reference to FIG. 1.

FIG. 1 is a perspective view of a liquid crystal display according to an exemplary embodiment of the present invention.

As shown in FIG. 1, a liquid crystal display 750 according to the present exemplary embodiment includes a pair of display panel assemblies 80 and 90 including a lower panel assembly 80 and an upper panel assembly 90, and a backlight unit 75. The liquid crystal display 750 also further includes a lower polarizer 12 disposed under the lower panel assembly 80, an upper polarizer 13 disposed on the upper panel assembly 90, a middle polarizer 20, and a diffuser 30. The middle polarizer 20 and diffuser 30 are disposed between the lower panel assembly 80 and the upper panel assembly 90. The middle polarizer 20 and the diffuser 30 may be omitted.

The middle polarizer 20 is disposed between the lower panel assembly 80 and the upper panel assembly 90, and controls the amount of light incident to the upper panel assembly 90. The middle polarizer 20 is surface-treated to have a light dispersion degree of about 70-100 haze such that it may have the function of a diffuser. Here, the light dispersion degree is increased as the haze value of the middle polarizer 20 is increased.

The diffuser 30 diffuses light passing through the middle polarizer 20 and is formed by overlapping a diffusion film and a BEF (brightness enhancing film), either singularly or multiply. The diffuser 30 may act to change the path of light. The diffuser 30 may be omitted when the middle polarizer 20 is surface-treated to have a predetermined light dispersion degree. However, the middle polarizer 20 having the predetermined light dispersion degree and the diffuser 30 may be used together.

The lower and the upper panel assemblies 80 and 90 respectively include lower panels 100a and 100b, upper panels 200a and 200b, and liquid crystal layers 3a and 3b. The liquid crystal layers 3a and 3b are formed between the lower panels 100a and 100b and the upper panels 200a and 200b.

The lower polarizer 12 and the upper polarizer 13 are respectively attached on the outside surfaces of the lower panel 100a of the lower panel assembly 80 and the upper panel 200b of the upper panel assembly 90 via the lower and upper panel assemblies 80 and 90 that are opposite to each other.

The lower panel assembly 80 and the upper panel assembly 90 may have equivalent structures.

The middle polarizer 20 may have a polarization axis that is parallel or perpendicular to the polarization axis of the lower and upper polarizers 12 and 13 according to the mode of the liquid crystal display.

In the structure of the liquid crystal display, when the lower and upper panel assemblies 80 and 90 display black, leakage light passing through the lower panel assembly 80 and the middle polarizer 20 is blocked by the upper polarizer 13 of the upper panel assembly 90 such that the black display may be increased.

Light passing through the middle polarizer 20 is diffused by the diffuser 30 and is incident to the upper panel assembly 90 in the white state. Accordingly, the moiré interference effect due to the periodic pattern alignment of the lower panel assembly 80 and the upper panel assembly 90 (the light blocking members 220a and 220b) is reduced or not generated.

As discussed above, moiré interference is interference that is generated when the spatial patterns having periodic characteristics are overlapped, and the light patterns generated by the moiré interference have larger periods than the original period of the pattern of the light blocking member 220a and 220b. Accordingly, if the moiré interference is generated, the user may easily recognize it. This moiré patterns recognized by the user because of the moiré interference deteriorates the display quality of the display device.

However, in the liquid crystal display 750 according to the present exemplary embodiment, the light passing through the lower display panel assembly 80 is diffused by the diffuser 30 or the middle polarizer 20 of which the surface is haze-treated such that it is difficult for the moiré interference to be generated. Accordingly, the deterioration of the display quality of the display device may be reduced or prevented.

The lower panel assembly 80 and the upper panel assembly 90 may be driven by the same driving signal, or may be independently driven.

The backlight unit 75 includes at least one light source for providing light to the panel assemblies 80 and 90. For example, the light source may be a fluorescent lamp such as a CCFL (cold cathode fluorescent lamp) or an EEFL (external electrode fluorescent), and a plurality of lamps may be used.

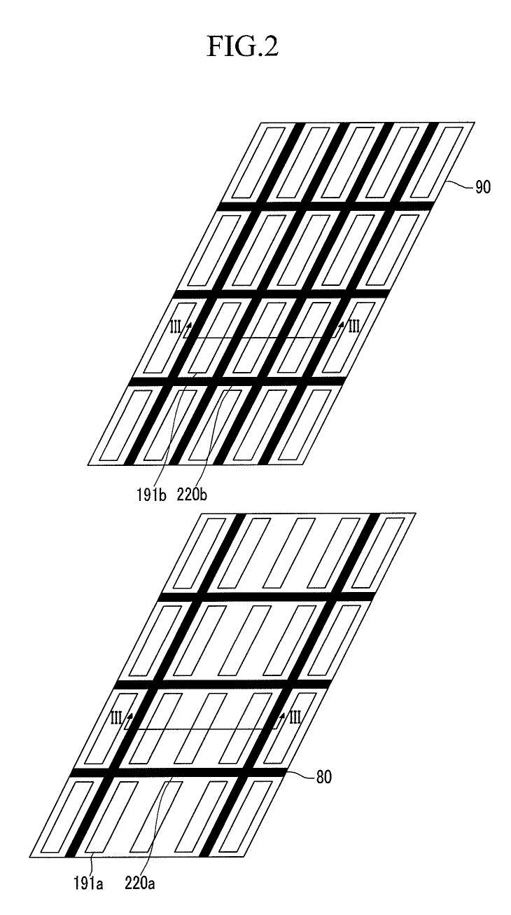

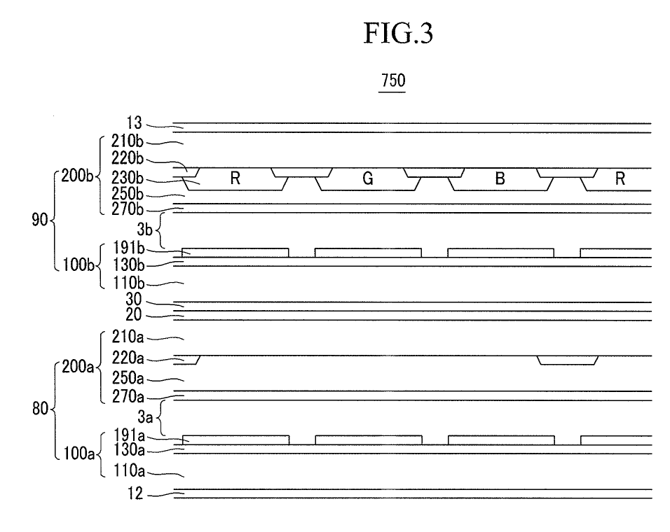

An LCD and an operation thereof according to an exemplary embodiment of the present invention will be described in detail below with reference to FIG. 2 and FIG. 3.

FIG. 2 is a perspective view of a liquid crystal display according to an exemplary embodiment of the present invention, and FIG. 3 is a cross-sectional view of the liquid crystal display shown in FIG. 2 taken along the line III-III.

Referring to FIG. 2 and FIG. 3, a liquid crystal display according to the present exemplary embodiment includes a lower panel assembly 80, an upper panel assembly 90, and a backlight unit (not shown).

The lower and upper panel assemblies 80 and 90 respectively include lower panels 100a and 100b, upper panels 200a and 200b, and liquid crystal layers 3a and 3b. A middle polarizer 20 and a diffuser 30 are disposed between the lower panel assembly 80 and the upper panel assembly 90. A lower polarizer 12 is disposed under the lower panel assembly 80, and an upper polarizer 13 is disposed on the upper panel assembly 90. The middle polarizer 20 and the diffuser 30 may be omitted.

The middle polarizer 20 controls the amount of light incident to the upper panel assembly 90 and this middle polarizer 20 may be surface-treated to have a light dispersion degree of about 70-100 haze. Here, the light dispersion degree is increased as the haze value of the middle polarizer 20 is increased.

The diffuser 30 diffuses the light passing through the middle polarizer 20 to change the path of the light.

The lower panels 100a and 100b respectively include insulating substrates 110a and 110b, and a plurality of thin film elements 130a and 130b and a plurality of pixel electrodes 191a and 191b that are formed thereon respectively.

The thin film elements 130a and 130b include thin film transistors for switching pixel electrodes 191a and 191b, signal lines, capacitors, etc.

The pixel electrodes 191a and 191b are disposed on the thin film elements 130a and 130b, and may be made of crystallized ITO (indium tin oxide) or amorphous ITO or IZO (indium zinc oxide). However, the pixel electrodes 191a and 191b may be disposed between the thin film elements 130a and 130b, or may be disposed between the substrates 110a and 110b and the thin film elements 130a and 130b.

The upper panel 200b of the upper panel assembly 90 includes an insulating substrate 210b, a light blocking member 220b thereon, a plurality of color filters 230b, an overcoat 250b, and a common electrode 270b.

The light blocking member 220b and the color filters 230b contact the substrate 210b, and the color filters 230b are disposed opposite to the pixel electrodes 191b and may include filters for the additive primary colors of red, green, and blue. The overcoat 250b covers the color filters 230b and the light blocking member 220b, and has a flat surface. The common electrode 270b is disposed on the overcoat 250b, and is preferably made of a transparent conductive material such as ITO, amorphous ITO, or IZO.

The upper panel 200a of the lower panel assembly 80 includes an insulating substrate 210a, a light blocking member 220a, an overcoat 250a, and a common electrode 270a thereon.

The light blocking member 220a, as shown in FIG. 2, encloses regions corresponding to one dot including three pixel electrodes 191b. However, the light blocking member 220a may be varied with a different structure from the light blocking member 220b of the upper panel assembly 90.

The overcoat 250a covers the light blocking member 220a and has a flat surface. The common electrode 270a is disposed on the overcoat 250a, and is preferably made of a transparent conductive material such as ITO, amorphous ITO, or IZO.

Alternatively, the lower panel assembly 80 may have the arrangement of the upper panel assembly 90, as described above, while the upper panel assembly 90 may have the arrangement of the lower panel assembly 80, as described above.

As above-described, the color filters 230b are disposed on the upper panel assembly 90. The light blocking member 220a of the lower display panel assembly 80 and the light blocking member 220b of the upper display panel assembly 90 have a pattern with a different repeated period, and accordingly the moiré interference effects may be reduced or eliminated.

Also, because there are no color filters in the lower panel assembly 80 of the liquid crystal display, it is not necessary to align the color filters, and the light efficiency of the display device may be increased.

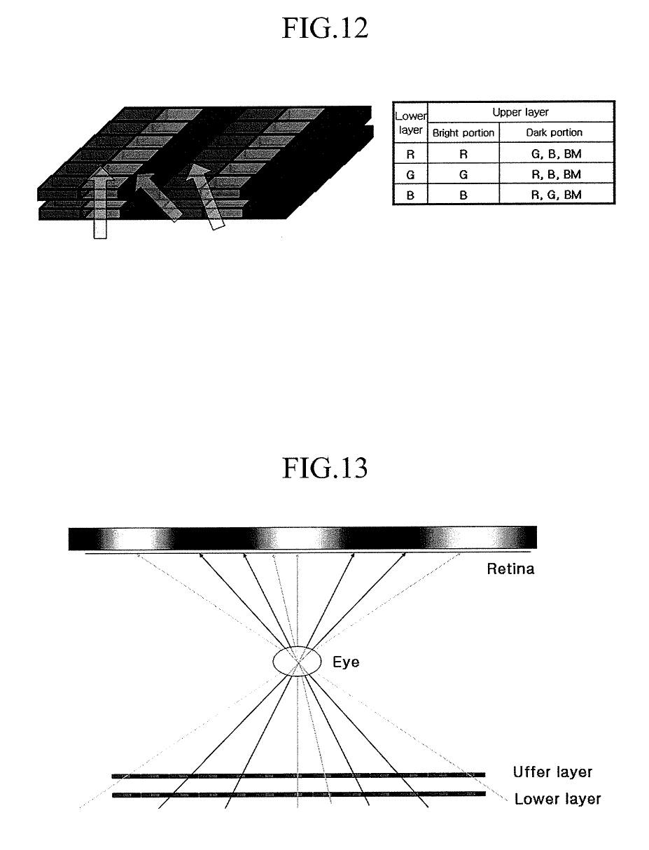

Next, an operation for reducing the moiré interference effects according to an exemplary embodiment of the present invention will be described in detail below with reference to FIG. 12 to FIG. 16.

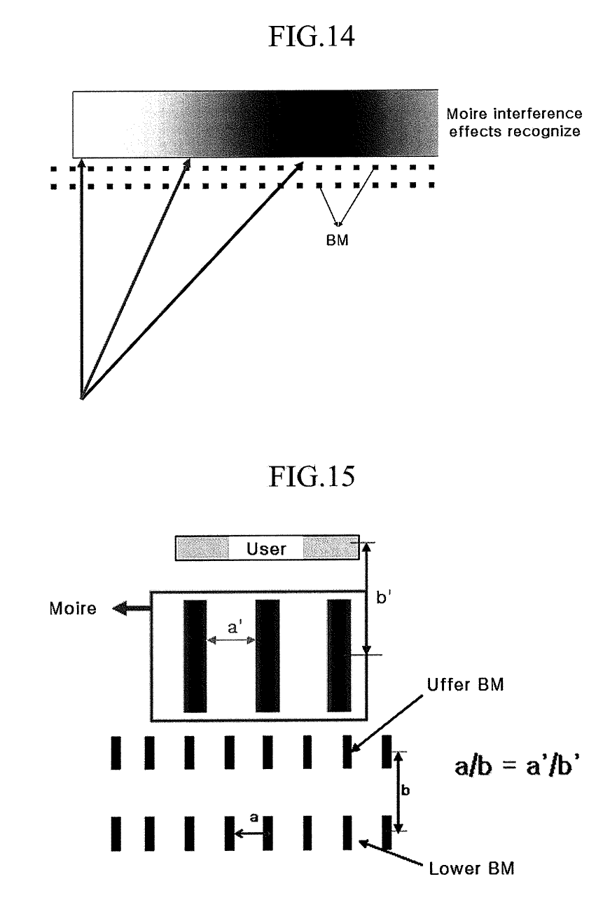

FIG. 12 and FIG. 13 are views showing moiré interference due to the overlapping of the color filters, and FIG. 14 to FIG. 16 are views showing moiré interference due to the overlapping of the light blocking members.

First, referring to FIG. 12, when light is passed through each color filter, the light of the corresponding gradient to the color filter is passed, but the rest of the gradients are blocked. Accordingly, when the light passing through the red color filter is then passed through the blue color filter or the green color filter, little light is passed such that black is represented, and the light passing through the red color filter is red light. In a like manner, when the light passing through the blue color filter is then passed through the red color filter or the green color filter, black is represented, and when the light passing through the green color filter is then passed through the blue color filter or the red color filter, black is represented. The bright portion and the dark portion are divided according to the paths of the light passing through the lower and upper panels. These, as shown in FIG. 13, are represented as the brightness and darkness patterns that the user may recognize.

Next, referring to FIG. 14, when light blocking members are formed on the upper and lower panels and are properly aligned, depending on the angle at which the beams of light travel through the two panels, light may be blocked by neither panel, blocked by one panel or blocked by both panels. As a result, a repeating pattern of bright spots and dark spots is visible to the user.

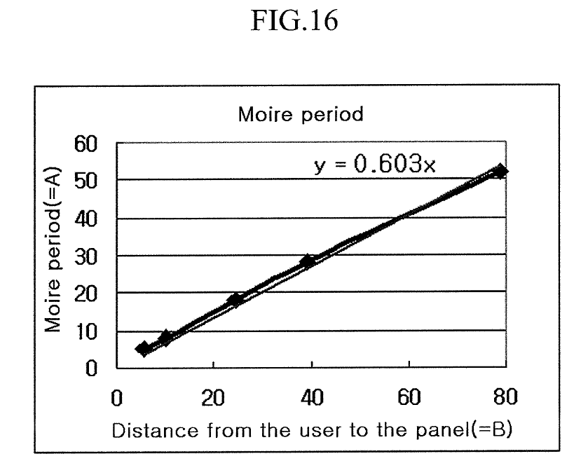

The sizes or the shapes of the moiré patterns vary according to the size of the pixels, the position of the user, the interval between the upper and lower panels, etc. As shown in FIG. 15, the factors that contribute to the moiré equation of a/b=a′/b′ are illustrated. The value of the interval a between the light blocking members divided by the interval b between the upper and lower panels is nearly the same as the value of the period a′ of the moiré patterns divided by the distance b′ from the panel to the user. Accordingly, the interval a between the light blocking members and the interval b between the upper and lower panels are proportional to the period a′ of the moiré patterns and the distance b′ to the user, as shown in FIG. 16. Here, the proportional constant value is determined by the ratio between the interval a between the light blocking members and the interval b between the upper and lower panels.

As above-described, the moiré interference is generated by the overlaps of the color filter and the light blocking members in the flat panel display including the two overlapping panels. Accordingly, the color filters are not formed on the lower panel assembly 80 in the exemplary embodiment of the present invention, and the light blocking member 220a of the lower panel assembly 80 is formed with a different shape from the light blocking member 220b of the upper panel assembly 90, thereby reducing the moiré interference effects.

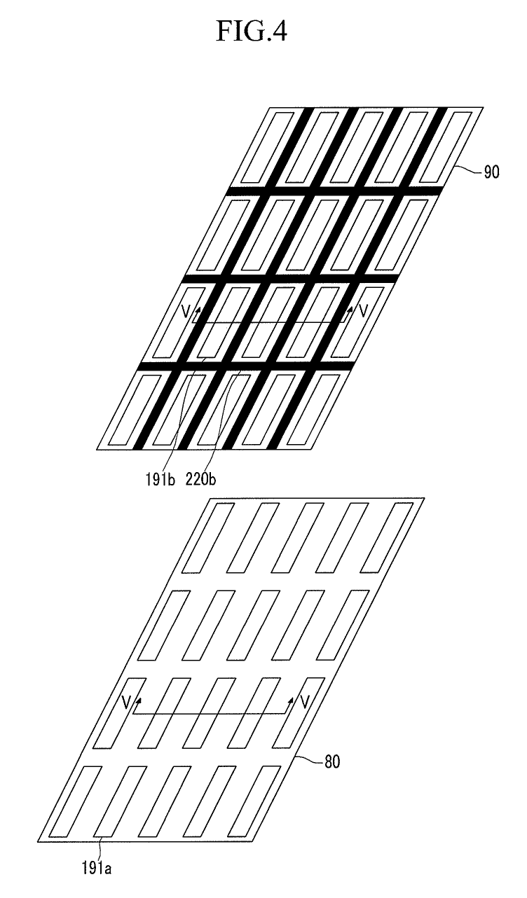

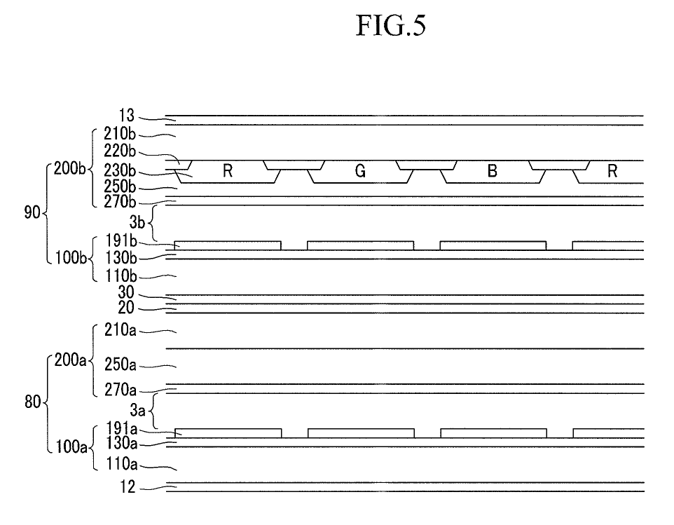

A liquid crystal display according to an exemplary embodiment of the present invention will now be described in detail with reference to FIG. 4 and FIG. 5.

FIG. 4 is a perspective view of a liquid crystal display according to an exemplary embodiment of the present invention, and FIG. 5 is a cross-sectional view of the liquid crystal display shown in FIG. 4 taken along the line V-V.

In FIG. 4 and FIG. 5, the same or similar components to those shown in FIG. 2 and FIG. 3 are indicated by the same reference numerals.

In the liquid crystal display according to the exemplary embodiment of the present invention, as shown in FIG. 4 and FIG. 5, a light blocking member 220a of the lower panel assembly 80 is not present. This is in contrast to in the liquid crystal display discussed above with reference to FIG. 2. In FIGS. 4 and 5, a light blocking member 220b and a color filter 230b are formed in the upper panel assembly 90, but a light blocking member and a color filter are not formed in the lower display panel assembly 80.

The positions of the lower panel assembly 80 and the upper panel assembly 90 may be exchanged.

In this structure, the moiré interference effects generated by the overlaps of the color filter and/or light blocking member of the upper panel assembly 90 may be removed.

Also, because the color filter and the light blocking member are not formed in the lower panel assembly 80, when the upper panel assembly 90 and the lower panel assembly 80 are combined, it is not necessary to align the color filter and the light blocking member, and the light efficiency of the display device is increased.

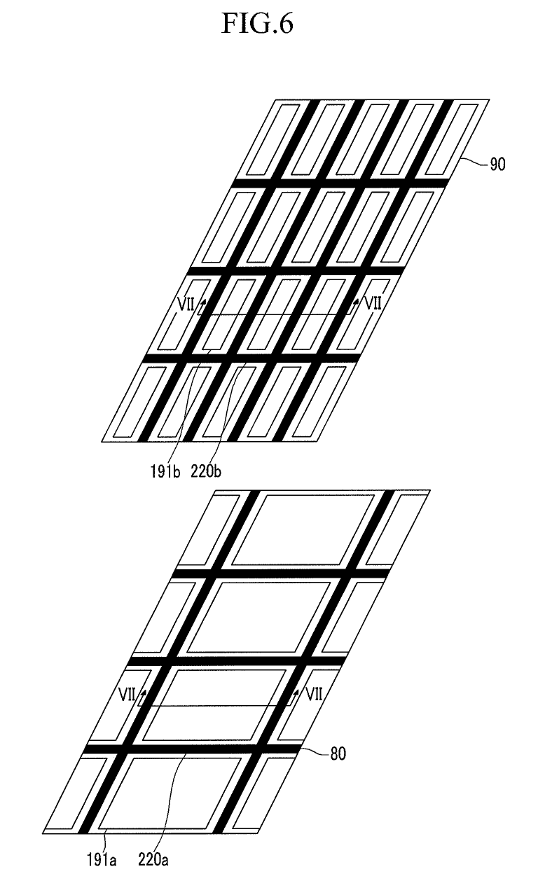

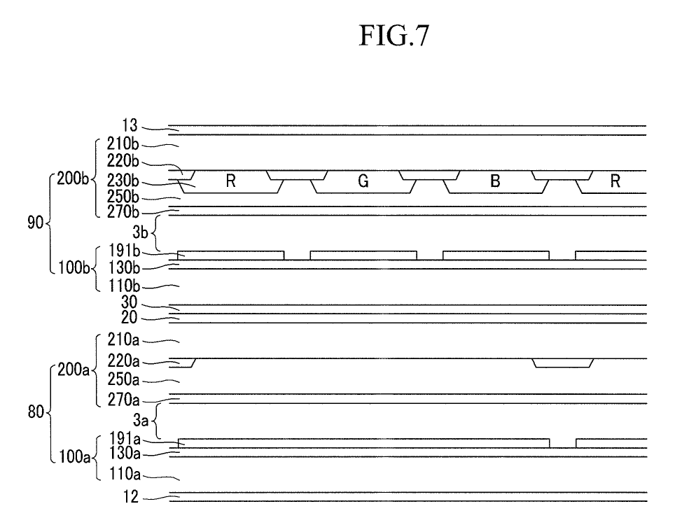

Next, a liquid crystal display according to another exemplary embodiment of the present invention will be described in detail with reference to FIG. 6 and FIG. 7.

FIG. 6 is a perspective view of a liquid crystal display according to an exemplary embodiment of the present invention, and FIG. 7 is a cross-sectional view of the liquid crystal display shown in FIG. 6 taken along the line VII-VII.

In FIG. 6 and FIG. 7, the same or similar components to those shown in FIG. 2 and FIG. 3 are indicated by the same reference numerals.

As shown in FIG. 6 and FIG. 7, the size of one pixel electrode 191a provided in a lower panel 100a of the lower panel assembly 80 is nearly the same as the size of the three pixel electrode 191b of the upper panel assembly 90 in the liquid crystal display according to the exemplary embodiment of the present invention discussed above with reference to FIG. 6, as opposed to in the liquid crystal display according to the exemplary embodiment discussed above with reference to FIG. 2. The size of the pixel electrode 191a of the lower panel assembly 80 is substantially the same as one dot that is made of a plurality of pixel electrodes 191b of upper panel assembly 90. However, the pixel electrode 191a may have larger or smaller size than one dot. For example, the pixel electrode 191a may be formed with a size corresponding to four or two pixel electrodes 191b of the upper panel assembly 90.

This lower panel assembly 80 is driven by dot units, and the highest gray voltage among the gray voltages applied to the pixel of the upper panel assembly 90 corresponding to the dot is applied to each dot.

The positions of the lower panel assembly 80 and the upper panel assembly 90 may be exchanged.

As above-described, the repeating patterns of the lower panel assembly 80 and the upper panel assembly 90 are different from each other in the exemplary embodiment of the present invention discussed above with respect to FIG. 6, thereby reducing the moiré interference effects.

Also, because the number of pixel electrodes 191a of the lower panel assembly 80 is reduced in the present exemplary embodiment compared with the exemplary embodiments discussed above with respect to FIGS. 2 and 4, the number of thin film transistors (not shown) connected to the pixel electrodes 191a is reduced such that the number of driving circuits of the lower panel assembly 80 may be decreased.

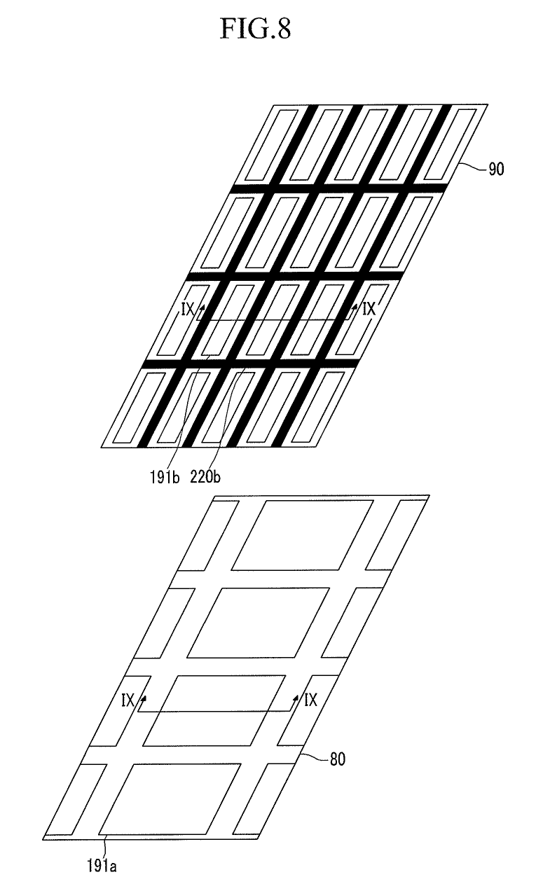

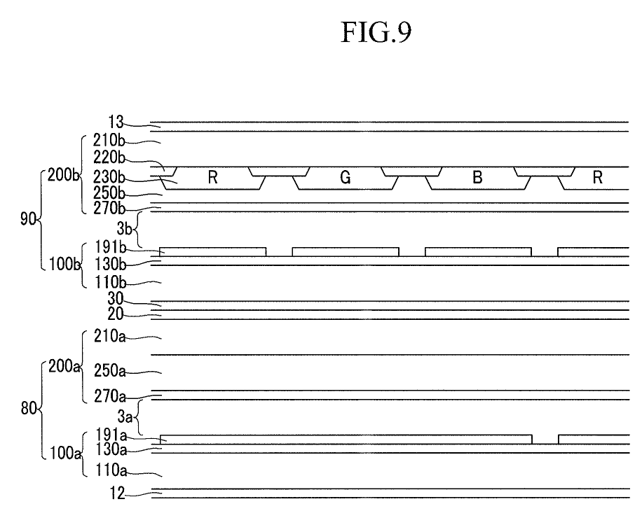

Next, a liquid crystal display according to an exemplary embodiment of the present invention will be described in detail with reference to FIG. 8 and FIG. 9.

FIG. 8 is a perspective view of a liquid crystal display according to an exemplary embodiment of the present invention, and FIG. 9 is a cross-sectional view of the liquid crystal display shown in FIG. 8 taken along the line IX-IX.

In FIG. 8 and FIG. 9, the same or similar components to those shown in FIG. 6 and FIG. 7 are indicated by the same reference numerals.

As shown in FIG. 8 and FIG. 9, the light blocking member 220a of the lower panel assembly 80 is not formed in the liquid crystal display. This is in contrast to in the liquid crystal display according to the exemplary embodiment discussed above with reference to FIG. 6. Color filters 230b and the light blocking member 220b are formed in the upper panel assembly 90, but a light blocking member and a color filter are not formed in the lower panel assembly 80.

The positions of the lower panel assembly 80 and the upper panel assembly 90 may be exchanged.

Compared with the structure of FIG. 6 and FIG. 7, because the light blocking member 220a is not formed on the lower panel 100a of the lower display panel assembly 80 in the present exemplary embodiment, the manufacturing process may be simplified and the cost may be reduced.

In this structure, the moiré interference effects generated by the overlaps of the color filter or the light blocking member of the lower panel assembly 80 and the upper panel assembly 90 are removed.

Also, because neither the color filter nor the light blocking member are formed in the lower panel assembly 80, when the upper panel assembly 90 and the lower panel assembly 80 are combined, aligning of the color filter and the light blocking member is not necessary and the light efficiency of the display device is increased.

Also, because the number of pixel electrodes 191a is reduced such that the number of thin film transistors (not shown) connected to the pixel electrodes 191a is reduced, the number of driving circuits of the lower panel assembly 80 may be decreased.

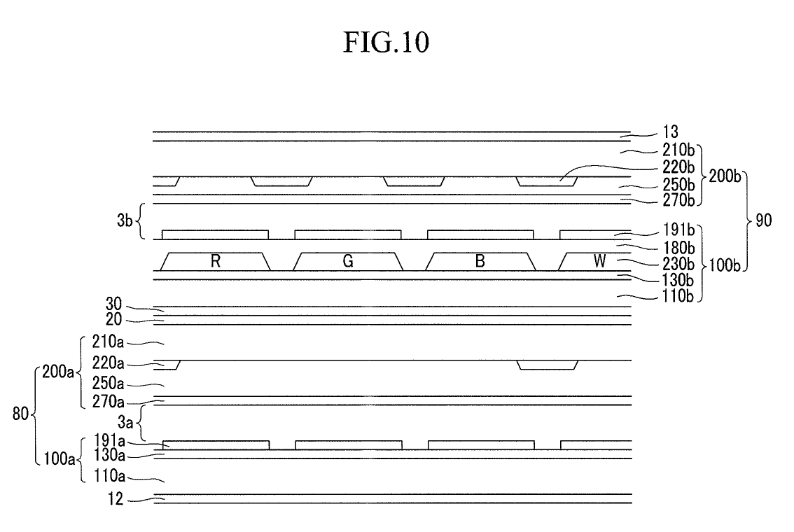

FIG. 10 is a cross-sectional view of a liquid crystal display according to an exemplary embodiment of the present invention.

In FIG. 10, the same or similar components to those shown in FIG. 3 are indicated by the same reference numerals.

The lower panel assembly 80, the upper and lower polarizers 12 and 13, the middle polarizer 20, and the diffuser 30 of the liquid crystal display may be the same as the corresponding elements of the liquid crystal display of FIG. 2 and FIG. 3.

The upper panel assembly 90 of the liquid crystal display includes a lower panel 100b, an upper panel 200b, and a liquid crystal layer 3b therebetween.

The lower panel 100b includes an insulating substrate 110b, a plurality of thin film elements 130b, color filters 230b formed on the thin film elements 130b, an overcoat 180b covering the color filters 230b, and a plurality of pixel electrodes 191b. Here, the color filters 230b may include white color filters as well as red, green, and blue color filters. The white color filters may be made of a transparent photosensitive film.

The upper panel 200b includes an insulating substrate 210b, a light blocking member 220b, an overcoat 250b, and a common electrode 270b. Here, the overcoat 250b may be omitted.

Also, the lower panel assembly 80 may be replaced with the lower panel assembly 80 as provided in the exemplary embodiments discussed above with respect to FIGS. 4 and 8.

Also, the positions of the lower panel assembly 80 and the upper panel assembly 90 may be exchanged.

In the exemplary embodiment of the present invention shown in FIG. 10, the color filter is not formed in the lower panel assembly 80, and the light blocking member 220a of the lower panel assembly 80 has a different shape from the light blocking member 220b of the upper panel assembly 90 such that the moiré interference effects may be reduced. Also, the color filters 230b are formed on the lower panel 100b of the upper panel assembly 90 such that the alignment margin between the lower panel 100b and the upper panel 200b of the upper panel assembly 90 may be increased.

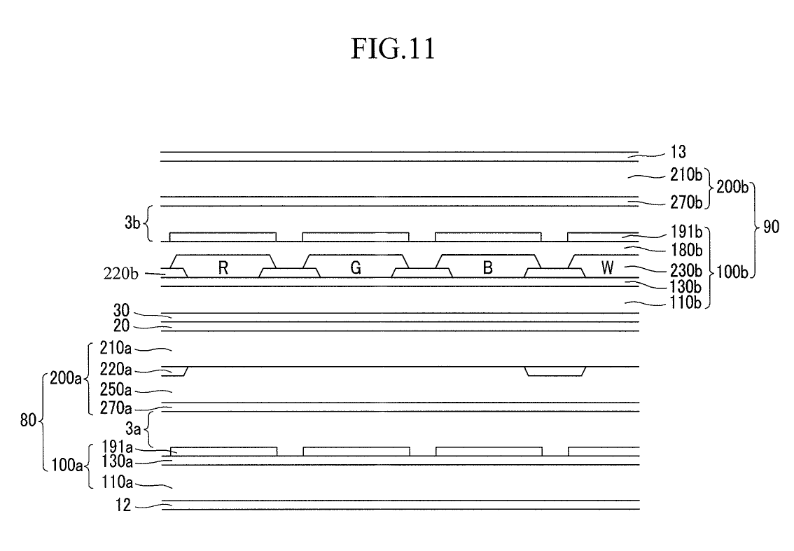

FIG. 11 is a cross-sectional view of a liquid crystal display according to an exemplary embodiment of the present invention.

In FIG. 11, the same or similar components to those shown in FIG. 10 are indicated by the same reference numerals.

Here, the light blocking member 220b is formed on the lower panel 100b of the upper panel assembly 90 in the liquid crystal display, as opposed to the exemplary embodiment discussed above with reference to FIG. 10. The light blocking member 220b and color filters 230b are formed on the plurality of thin film elements 130b.

Here, the lower panel assembly 80 may be replaced with the lower panel assemblies 80 discussed above with reference to FIGS. 4 and 8.

Also, the positions of the lower panel assembly 80 and the upper panel assembly 90 may be exchanged.

In the exemplary embodiment of the present invention shown in FIG. 11, the color filters are not formed in the lower panel assembly 80, and the light blocking member 220a of the lower panel assembly 80 has a different shape from the light blocking member 220b of the upper panel assembly 90 such that the moiré interference effects are reduced, and the light blocking member 220b and the color filter 230b are formed on the lower panel 100b of the upper panel assembly 90 such that the alignment margin of the lower panel 100b and the upper panel 200b of the upper panel assembly 90 may be increased.

The above-described exemplary embodiments of the present invention may be adapted to different display devices.

It is to be understood that the invention is not limited to the disclosed exemplary embodiments, but, on the contrary, is intended to cover various modifications and equivalent arrangements included within the spirit and scope.

What is claimed is:

1. A display device comprising:
a first panel assembly including a first substrate, at least one thin film transistor and a first pixel electrode formed on the first substrate, a second substrate opposite to the first substrate and a first common electrode formed on the second substrate, a first liquid crystal layer formed between the first substrate and the second substrate, a color filter formed on one of the first substrate and the second substrate, and a first light blocking member formed on one of the first substrate and the second substrate; and
a second panel assembly including a third substrate, at least one thin film transistor and a second pixel electrode formed on the third substrate, a fourth substrate opposite the third substrate and a second common electrode formed on the fourth substrate, and a second liquid crystal layer formed between the third substrate and the fourth substrate, wherein the second panel assembly does not have a color filter,
wherein the first panel assembly and the second panel assembly are overlapped with each other.

2. The display device of claim 1, further comprising
a diffuser disposed between the first panel assembly and the second panel assembly.

3. The display device of claim 2, further comprising
a polarizer disposed between the first panel assembly and the second panel assembly, and having a predetermined light dispersion degree.

4. The display device of claim 3, wherein
the fourth substrate of the second panel assembly further includes a second light blocking member having a different shape from the first light blocking member.

5. The display device of claim 4, wherein
the first light blocking member encloses a region corresponding to each first pixel electrode, and the second light blocking member encloses a region corresponding to one dot including three second pixel electrodes.

6. The display device of claim 4, wherein
one of the second pixel electrodes is employed on a region corresponding to three first pixel electrodes, the first light blocking member encloses a region corresponding to each first pixel electrode, and the second light blocking member encloses a region corresponding to each second pixel electrode.

7. The display device of claim 6, wherein
a highest gray voltage among gray voltages applied to the first pixel electrode is applied to the second pixel electrode.

8. The display device of claim 1, wherein
the fourth substrate of the second panel assembly further includes a second light blocking member having a different shape from the first light blocking member.

9. The display device of claim 8, wherein
the first light blocking member encloses a region corresponding to the first pixel electrode, and the second light blocking member encloses a region corresponding to one dot including three second pixel electrodes.

10. The display device of claim 1, wherein
the second pixel electrode is provided on a region corresponding to three first pixel electrodes.

11. The display device of claim 10, wherein
a highest gray voltage among gray voltages applied to the first pixel electrode is applied to the second pixel electrode.

12. The display device of claim 1, wherein
the color filter is formed on the first substrate, and the first light blocking member is formed on the second substrate.

13. The display device of claim 12, wherein
the color filter include red, green, blue, and white color filters.

14. The display device of claim 1, wherein
the color filter and the first light blocking member are formed on the first substrate.

15. The display device of claim 14, wherein
the color filter include red, green, blue, and white color filters.

16. A display device comprising:
a first display panel assembly including first thin film elements including at least one first thin film transistor, a first pixel electrode switched by the first thin film transistor, a first common electrode opposing the first pixel electrode, and a light blocking member; and
a second display panel assembly including second thin film elements including at least one second thin film transistor, a second pixel electrode switched by the second thin film transistor, and the second common electrode opposing the second pixel electrode, wherein the second display panel assembly does not have a light blocking member,
wherein the first display panel assembly and the second display panel assembly are overlapped with each other.

17. The display device of claim 16, further comprising
a diffuser disposed between the first display panel assembly and the second display panel assembly.

18. The display device of claim 17, further comprising
a polarizer disposed between the first display panel assembly and the second display panel assembly and having a predetermined light dispersion degree.

19. The display device of claim 18, wherein
the polarizer has a light dispersion degree of 70-100 haze.

20. The display device of claim 16, wherein
the second pixel electrode is provided on a region corresponding to three first pixel electrodes.
